(19) United States
(12) Patent Application Publication
(10) Pub. No.: US 2011/0283010 A1
(43) Pub. Date: Nov. 17, 2011

(54) Method and system for validating interactive multimedia applications for use in enhanced or interactive television systems

(75) Inventors: Travis R. Parchman, Philadelphia, PA (US); Eric E. Robinson, Jenkintown, PA (US); Raymond J. Gilbert, Lansdale, PA (US); Andrew L. Fransman, Sharon, MA (US)

(73) Assignee: SeaChange International, Acton, MA (US)

(21) Appl. No.: 12/855,564

(22) Filed: Aug. 12, 2010

Related U.S. Application Data
(60) Provisional application No. 61/333,525, filed on May 11, 2010.

(51) Int. Cl. G06F 15/16

(52) U.S. Cl. 709/231

(57) ABSTRACT

Disclosed herein are embodiments of a computerized system and method of validating an application contained within a multimedia transport stream. Such embodiments can include the steps of, or structure for, reading data from a multimedia transport stream by a computer, the data representing an application that presents viewable content when executed by a display device and comprises a reference to an identifier of an external resource utilized by the application during execution; and prior to delivery of the multimedia transport stream to a display device, modifying the multimedia transport stream by the computer such that the external resource is not requested by the display device. In some embodiments, the transport stream is modified in response to the computer determining that the external resource is not available.

### RELATED APPLICATION(S)

This application claims the benefit of U.S. Provisional Patent Application No. 61/333,525, filed on May 11, 2010, the entire teachings of which incorporated herein by reference.

### FIELD OF THE INVENTION

The present invention relates generally to computerized methods and systems for delivering interactive multimedia applications for use in enhanced or interactive television systems, and particularly to methods, systems and computer program products for validating such application prior to delivery to a display device.

### BACKGROUND

Enhanced TV Binary Interchange Format (EBIF) is a multimedia content format defined by a specification developed under the OpenCable project of CableLabs (Cable Television Laboratories, Inc.). The purpose of the EBIF content format is to represent a collection of widget and byte code specifications that define one or more multimedia pages, similar to web pages, but specialized for use within an enhanced television or interactive television system. An EBIF resource is a sequence of bytes, including files, that conforms to the EBIF content format and forms the primary information contained in an EBIF application (also referred to as an ETV application). In other words, an EBIF application is a collection of resources that include one or more EBIF resources that represent viewable information in the form of pages. An ETV User Agent acquires, decodes, presents widgets, and executes actions contained in an EBIF resource in order to present a multimedia page to an end-user. An on-demand media stream is one kind of resource currently defined for use with EBIF.

Operators of interactive or enhanced television systems deploy EBIF applications for a number of reasons. For example, EBIF applications are typically embedded within MPEG-2 transport streams carrying commercial content and executed by a set top box to present interactive or enhanced content to a viewer during or in lieu of the commercial content. Such EBIF applications can be sourced either from a national/regional feed for a given channel or via a local multimedia insertion system, such as the SPOT advertising insertion system from SeaChange International, Inc.

### SUMMARY OF THE INVENTION

EBIF applications typically utilize external resources to enhance their effectiveness. External resources include video-on-demand (VOD) assets, email systems and phone numbers. A television system operator does not want to present an EBIF application that uses external resources that are unavailable. For example, operators do not want to broadcast an EBIF application that offers VOD streaming options unless the referenced VOD assets are available to stream to the devices that the application would execute on. In another example, operators do not want to broadcast an EBIF application that offers to generate an email to a customer if an email gateway or other application server is not reachable by the network communications subsystems of devices that the application would execute on. In still another example, operators do not want to broadcast an EBIF application that presents an “800”-number if that particular number is not valid from the households containing the devices that the application would execute on. There is currently no mechanism for quickly and efficiently determining the availability of external resources referenced by EBIF applications, and especially during the limited advertising windows (e.g., 15-30 seconds) that many EBIF applications would be inserted in.

Accordingly, embodiments of the invention are disclosed herein for validating an application contained within a multimedia transport stream.

For example, a computerized method is disclosed for validating an application contained within a multimedia transport stream. Such method can comprise the steps of (i) reading data from a multimedia transport stream by a computer, the data representing an application that presents viewable content when executed by a display device and comprises a reference to an identifier of an external resource utilized by the application during execution; and (ii) prior to delivery of the multimedia transport stream to a display device, modifying the multimedia transport stream by the computer such that the external resource is not requested by the display device.

A computer program product, tangibly embodied in a computer readable medium, is disclosed for validating an application contained within a multimedia transport stream. Such computer readable medium can comprise instructions being executable to cause data processing apparatus to (i) read data from a multimedia transport stream by a computer, the data representing an application that presents viewable content when executed by a display device and comprises a reference to an identifier of an external resource utilized by the application during execution; and (ii) prior to delivery of the multimedia transport stream to a display device, modify the multimedia transport stream by the computer such that the external resource is not requested by the display device.

A computerized system is disclosed for validating an application contained within a multimedia transport stream, comprising a validation server system connected to a computer network between a feed and a display device. The validation server system can intercept a multimedia transport stream from the feed and read data from the transport stream. The data represents an application that presents viewable content when executed by the display device and comprises a reference to an identifier of an external resource utilized by the application during execution. Prior to delivery of the multimedia transport stream to a display device, the validation server system can modify the multimedia transport stream such that the external resource is not requested by the display device.

A computerized system is disclosed for validating an application contained within a multimedia transport stream, comprising a validation server system connected to a multimedia insertion server system that causes insertion of a stored multimedia transport stream into a scheduled timeslot of another multimedia transport stream being delivered to a display device. The validation server system can read data from the stored multimedia transport stream. The data represents an application that presents viewable content when executed by the display device and comprises a reference to an identifier of an external resource utilized by the application during execution. Prior to insertion of the stored multimedia transport stream into the scheduled timeslot, the validation server system can modify the stored multimedia transport stream such that the external resource is not requested by the display device.

In any of the above embodiments, such method, computer program product or system can further comprise additional steps, instructions, or structure for determining whether the external resource is available; and in response to determining that the external resource is not available, modifying the multimedia transport stream such that the external resource is not requested by the display device.

In any of the above embodiments, such method, computer program product or system can further comprise additional steps, instructions, or structure wherein modifying the multimedia transport stream comprises effectively deleting the application from the multimedia transport stream by removing a program element defining the packet identifier (PID) carrying the application from a Program Map Table present in the multimedia transport stream.

In any of the above embodiments, such method, computer program product or system can further comprise additional steps, instructions, or structure wherein modifying the multimedia transport stream comprises effectively removing the external resource from the application by changing the reference from the identifier of the external resource to a null value.

In any of the above embodiments, such method, computer program product or system can further comprise additional steps, instructions, or structure wherein modifying the multimedia transport stream comprises effectively removing the external resource from the application by changing the reference from the identifier of the external resource to an identifier of an alternative external resource.

In any of the above embodiments, such method, computer program product or system can further comprise additional steps, instructions, or structure wherein effectively removing the external resource from the application further comprises obtaining the identifier of the alternative external resource from a data structure defined within the data representing the application, the data structure containing one or more identifiers associated with alternative external resources.

In any of the above embodiments, such method, computer program product or system can further comprise additional steps, instructions, or structure wherein effectively removing the external resource from the application further comprises obtaining the identifier of the alternative external resource from a rules server.

In any of the above embodiments, such method, computer program product or system can further comprise additional steps, instructions, or structure wherein the data representing the application further comprises data representing a primary content format and an alternative content format for presenting viewable content of the application, such that the data representing alternative content format lacks the reference to the external resource; and wherein modifying the multimedia transport stream comprises replacing the data representing the primary content format of the application with the data representing the alternative content format.

In any of the above embodiments, such method, computer program product or system can further comprise additional steps, instructions, or structure wherein the multimedia transport stream further comprises data representing a primary application and an alternate application for presenting viewable content, such that the data representing the primary application and the alternate application are each associated with a different packet identifier (PID); and wherein modifying the multimedia transport stream comprises effectively substituting the primary application with the alternate application in the multimedia transport stream by substituting the packet identifier of the primary application with the packet identifier of the alternate application in a Program Map Table present in the multimedia transport stream.

In any of the above embodiments, such method, computer program product or system can further comprise additional steps, instructions, or structure wherein the multimedia transport stream is intercepted from a remote feed prior to delivery to the display device.

In any of the above embodiments, such method, computer program product or system can further comprise additional steps, instructions, or structure wherein the multimedia transport stream is stored in a database in advance of delivery to the display device.

### BRIEF DESCRIPTION OF THE DRAWINGS

FIG. 1 is a diagram that illustrates a system for validating interactive multimedia applications for use in enhanced or interactive television systems according to one embodiment.

FIG. 2 is a flow diagram illustrating a method of validating interactive multimedia applications for use in enhanced or interactive television systems according to one embodiment.

The foregoing and other objects, features, and advantages of the present invention, as well as the invention itself, will be more fully understood from the following description of various embodiments, when read together with the accompanying drawings.

### DETAILED DESCRIPTION OF PREFERRED EMBODIMENTS

In some embodiments, the validation system can verify the availability of external resources (e.g., VOD assets) referenced in EBIF applications that are either intercepted as part of linear broadcast streams or previously stored for use in conjunction with multimedia insertion systems, such as advertising insertion systems. Where such external resources are not available, such validation systems can perform a number of responsive actions, including deletion, modification or substitution of the EBIF Application, or specific resources thereof, from the stream. As a result, downstream customers can be provided consistent multimedia television experiences, such as interactive advertising campaigns. In some embodiments, the validation system can perform such actions regardless of the availability of the external resources. The validation system can also be configured to provide alerts, for example, when problems are identified with the EBIF application, and preferably in forms commonly used by typical monitoring and alerting system (e.g., SNMP and email).

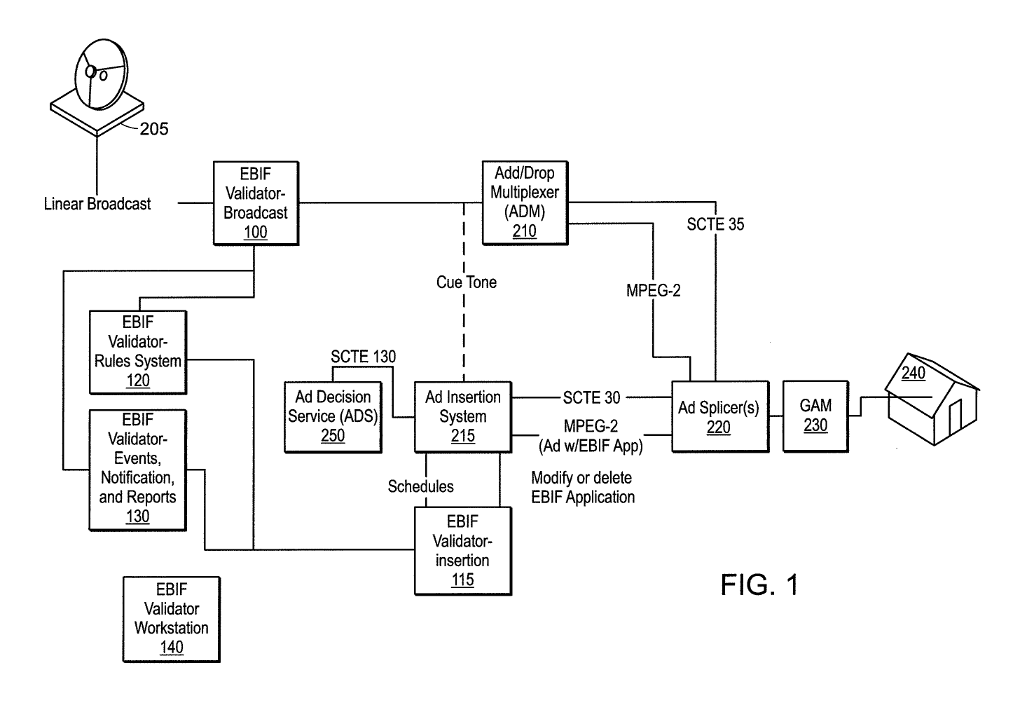

FIG. 1 is a diagram that illustrates a system for validating interactive multimedia applications for use in enhanced or interactive television systems according to one embodiment. As shown, the validation system 1 comprises a broadcast validation server system 110, an insertion validation server system 115, a rules server system 120 and an event server system 130. Alternative combinations of such server system components for validation can be employed.

Although not so limited, the validation system shown in FIG. 1 is employed within an HFC network infrastructure. The validation system can also be employed within other network infrastructures that provide enhanced or interactive television services to various display devices (e.g., set top clients, mobile phones and PCs).

As shown in FIG. 1, the broadcast validation server system 110 intercepts and performs validation services on broadcast streams containing EBIF applications sourced from national/regional feeds 205 prior to transmission to the subscriber premises 240 through an Add/Drop Multiplexer 210, Ad Splicer 220, QAM 230. Alternatively, the broadcast validation server system 110 can be arranged in-line between the ADM 210 and Ad Splicer 220 to perform its validation services on the EBIF applications from the intercepted MPEG-2 broadcast stream. The validation system can be employed to intercept and perform validation services on non-broadcast streams, such as on-demand streams containing EBIF applications or the like.

Likewise, the insertion validation server system 115 scans and performs validation services on video content containing EBIF applications stored, for example, in an advertising insertion system 215. Such validation services can be performed in advance of, or at least prior to, their selective insertion by the advertising insertion system 215 into scheduled time slots (avails) of a broadcast stream received by the Ad Splicer 220. The validation services can include alerting, deletion, modification, or substitution of the EBIF application, or specific resource(s) thereof.

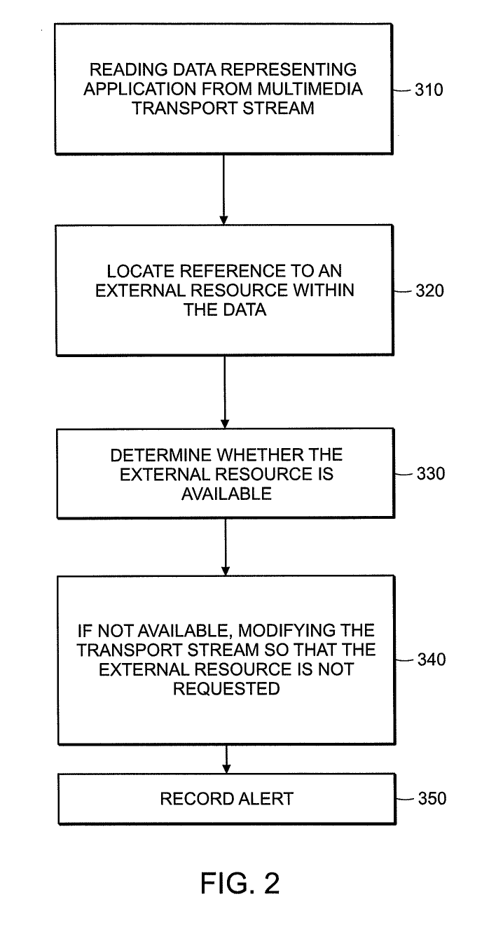

FIG. 2 is a flow diagram illustrating a method of validating for validating interactive multimedia applications for use in enhanced or interactive television systems according to one embodiment. For the purposes of example only, the application referred to herein is an EBIF application.

At step 310, data representing an EBIF application is read from a multimedia transport stream, such as an MPEG-2 transport stream. The EBIF application presents viewable content when executed by a display device, such as a set top client, mobile phone or PC. For example, in the context of the broadcast validation server system 110 of FIG. 1, the server system reads the EBIF application from an MPEG-2 transport stream that is intercepted from a national/regional feed 205. In the context of the insertion validation server system 115 which interoperates with an advertisement insertion system 215, the server system reads the EBIF application from an MPEG-2 transport stream stored at a database accessible to the ad insertion system 215. In both examples, the EBIF application is read prior to delivery to a display device.

At step 320, a reference is an external resource is located within the EBIF application. For example, where the external resource is a video on demand (VOD) asset, the reference can include a pair of identifiers, Provider ID and a Provider Asset ID (PID/PAID), which are used by an EBIF Application to identify the location of the VOD asset. The PID/PAID identifiers are typically stored within reference tables of the EBIF Application in the form of a URL (e.g., “vod://hbo.com/HBO20100512847298472”), where the Provider ID (PID) is a 20-byte string containing the domain of the content provider (e.g., “hbo.com”) and the Provider Asset ID (PAID) is a string containing the ID of the VOD asset (e.g., “HBO2010051284729847”).

At step 330, a determination is made as to whether the external resource is available. Upon extraction of the identifier of the external resource referenced in the application, the validation server systems 110, 115 can compare the identifier against a database to confirm that the resource is present and streamable. For example, in the case of VOD assets, the database can include one or more data stores associated with one or more video pumps from which such VOD asset can be streamed.

At step 340, if the external resource is determined to be unavailable, the multimedia transport stream is modified so that the external resource is not requested. For example, as discussed in more detail below, such modification can include deletion, modification, or substitution of the EBIF application, or specific resource(s) thereof.

At step 350, an alert can be recorded, for example, in the events server system 130. If the external resource is determined to be unavailable (e.g., not present or not streamable), the validation server systems 110, 115 can direct the events server system 130 to record a validation failure event and to issue a corresponding alert or other notification. Embodiments of the validation system 1 can provide other types of alerts when problems are found with an EBIF application. Alerts can be provided in the prevailing forms commonly used by monitoring and alerting systems (e.g. SNMP, email).

As previously discussed, embodiments of the validation server systems 110, 115 can modify a multimedia transport stream so that the external resource is not requested during execution of the EBIF application through deletion, modification, or substitution of the EBIF application, or specific resource(s) thereof. Particular embodiments of such modification are discussed in more detail below.

Deletion:

Embodiments of the validation system 1 can facilitate the deletion of the EBIF application in its entirety. In MPEG-2 streams, individual elements of the stream, such as audio, video and data streams (e.g., EBIF applications), are identified by an Elementary Packet Identifier (PID) contained within the program element list of a table referred to as a Program Map Table (PMT). Accordingly, an EBIF application can be effectively deleted from the broadcast stream by removing the program element defining the PID carrying the application from the PMT.

In the context of broadcast streams intercepted by broadcast validation server system, the broadcast validation server system 110 can delete the EBIF application from the Program Map Table (PMT) by removing the program element defining the PID carrying the application from the PMT. In particular, the PMT is typically repeated in both broadcast and on-demand streams many times per second. Accordingly, alteration of the PMT should be repeatedly applied to all occurrences of the PMT that are transmitted during the time which the EBIF application and any triggering logic may be present. The broadcast validation server system can perform this alteration for a fixed window of time that defines the length of the media clip containing the EBIF application; for the duration of its detection that an EBIF application that needs to be suppressed is inside its triggering window; or for the duration of any transmission of bytes containing the EBIF application or triggering logic that is to be suppressed.

In the context of video content stored by an advertising insertion system 215, the insertion validation server system 115 can signal the ad insertion system 215 to remove the program element defining the Packet Identifier (PID) carrying the application from the Program Map Table (PMT) prior to its insertion by the Ad Splicer 220 into the broadcast stream. For example, the server system 115 can employ an extension of SCTE-130 CIS signal protocol in order to cause suppression of the Packet Identifier (PID) of the EBIF application upon delivery of the video advertisement to the Ad Splicer 220.

Modification:

Embodiments of the validation system 1 can facilitate the modification of the EBIF application, including but not limited to, the methods described below.

Removal of the External Resource

In one embodiment, to effectively remove an external resource from an EBIF application, identifier(s) of the resource as defined within the EBIF application can be set to null. Optionally, application logic associated with the removed resource can be also changed or set to null.

For example, in the context of VOD assets, a pair of identifiers, Provider ID and a Provider Asset ID (PID/PAID), are used by an EBIF Application to identify the location of the VOD asset. The PID/PAID identifiers are typically stored within tables of the EBIF Application in the form of a URL (e.g., “vod://hbo.com/HBO20100512847298472”), where the Provider ID (PID) is allowed to be of variable length up to a 20-byte string containing the domain of the content provider (e.g., “hbo.com”) and the Provider Asset ID (PAID) is a 20-byte string containing the ID of the VOD asset (e.g., “HBO20100512847298472”). Thus, to effectively remove an external resource from an EBIF application, the validator server systems 110, 115 can set the URL string of the PID/PAID as a whole to null.

In the context of broadcast streams intercepted by broadcast validation server system, for example, the broadcast validation server system 110 can remove the external resource from the EBIF application by buffering the broadcast stream, referencing the resource table defined within the EBIF application of the broadcast stream and changing the identifier(s) associated with that resource to null.

Optionally, application logic associated with the resource being removed can be changed or set to null in order to prevent the display of any content (e.g. buttons) associated the external resource being removed. Such automated modification of the logic of an EBIF application can be implemented by originally compiling the application to contain “hints” and/or substitute logic that trigger such modification upon discovery that a referenced external resource is not available. For example, such hints and/or substitute logic can be defined or contained within data structures defined by the EBIF specification or extension thereof. Such hints and/or substitute logic can also be defined or contained within data structures defined in separate rules definition files external to the EBIF applications themselves. Such files can be packaged with the applications on distribution in order to provide alternative logic to be placed into the application upon discovery that a referenced external resource is not available. This alternative logic can take the form of specified modification of designated portions of the EBIF application itself or complete substitution of the EBIF application from amongst one or more alternative implementations.

Likewise, in the context of video content stored by an advertising insertion system 215, the insertion validation server system 115 can remove the external resource from the EBIF application by scanning the video content stored by the ad insertion system 215, referencing the resource table defined within the EBIF application and changing the identifier(s) associated with that resource to null. Optionally, application logic associated with the resource being removed can be changed, if not set to null, to prevent the display of any content (e.g. buttons) associated the external resource being removed.

Use of an Alternative External Resource

In one embodiment, to use an alternative external resource within an EBIF application, identifier(s) of the external resource previously defined within the EBIF application can be set to different identifier(s). For example, as previously discussed, VOD assets used within an EBIF application are identified within a table using a pair of identifiers in the form of a URL string (PID/PAID). In order to use an alternative external resource within the EBIF application, the validator server systems 110, 115 can substitute the stored URL string by changing the corresponding PID and/or PAID string values to the location of the alternative external resource.

In the context of broadcast streams intercepted by broadcast validation server system, for example, the broadcast validation server system 110 can change the external resource utilized within the EBIF application by buffering the broadcast stream, referencing the resource table defined within the EBIF application of the broadcast stream and changing the identifier(s) of the resource being substituted with the identifier of the alternative external resource.

Likewise, in the context of video content stored by an advertising insertion system 215, the insertion validation server system 115 can change the external resource utilized within the EBIF application by scanning the video content stored by the ad insertion system 215, referencing the resource table defined within the EBIF application and changing the identifier(s) of the resource being substituted with the identifier(s) of the alternative external resource.

The identifier(s) associated with the alternative external resource can be obtained from an application tag, external resource reference table or other data structure defined within the binary format of the EBIF application itself Accordingly, when the validation server systems 110, 115 detect that an external resource is unavailable, the validation server systems can substitute the identifier(s) of the unavailable resource with the identifier(s) of the alternative external resource obtained from the respective data structure.

The current EBIF Standard does not define any data structure within the binary format of an EBIF application from which to identify alternative external resources. Accordingly, such enhanced EBIF applications can be generated from templates that define application tags, external resource reference tables or other data structure that facilitate the selection and use of alternative resources during presentation of the EBIF application at the subscriber premises 240.

In some embodiments, the rules server system 120 can provide the identifier(s) of the replacement resources to the validation server systems 110, 115.

Conversion of the EBIF Application to Present Alternative Content for Requesting Information (e.g., Request for Information (RFI) Experiences)

In one embodiment, an EBIF application can be originally authored to present the viewer with alternative logic for changing the content presented by the EBIF application.

For example, where an EBIF application is originally defined with application logic for presenting content in a primary format including certain VOD assets and such assets are determined to be unavailable, the validation server systems 110, 115 can reference alternative application logic defined within the EBIF application itself for presenting a different content format. Such content format can include, for example, a form which enables the viewer to request information through another means (e.g., email, phone, etc).

In a preferred embodiment, the alternative application logic defined within the EBIF application can be obtained from an application format or layout defined within the binary format of the EBIF application itself. Accordingly, when the validation server systems 110, 115 detect that the primary external resource(s) are unavailable, the validation server systems can replace the primary application logic with the alternative logic defined in the respective application format or layout in order to change the content presented by the EBIF application.

The current EBIF Standard does not define any application format or layout within the binary format of an EBIF application to reference alternative logic for content presentation. Accordingly, such enhanced EBIF applications can be generated from templates that define application format or layout and business rules that can facilitate the selection and use of alternative application logic during presentation of the EBIF application at the subscriber premises 240.

In other embodiments, the rules server system 120 can provide the alternative application logic to the validation server systems 110, 115.

Substitution:

Embodiments of the validation system 1 can facilitate the substitution of an EBIF application as follows:

Selection of an Alternate EBIF Application

In one embodiment, to use an alternative EBIF application, the Program Map Table (PMT) defined within the MPEG-2 stream is modified to reference the Packet Identifier (PID) identifier associated with the alternative EBIF application and its associated metadata and/or signaling information.

For example, the elementary stream that carries an alternative EBIF application can be referenced via a descriptor applied to the program element in the Program Map Table (PMT). Accordingly, when the validation server systems 110, 115 are directed to substitute the primary EBIF application with an alternative EBIF application, the validation rules system 120 can indicate the descriptor applied to the elementary stream carrying the alternate application. The validation server systems can then discover the Packet Identifier (PID) of the elementary stream tagged with that descriptor and alter the PMT such that the PIDs of the primary and alternate streams are swapped.

The current EBIF Standard does not define a data structure within the binary format of an EBIF application to reference alternative EBIF applications. Accordingly, such enhanced EBIF applications can be generated from templates that define application tags, external resource reference tables or other data structure that can facilitate the selection and use of alternative EBIF applications during presentation at the subscriber premises 240.

Selection of an Alternate Video Source that Contains a Different EBIF Application

In another embodiment, substitution of an EBIF application can be performed by selecting a different video source that contains a different EBIF application.

In the context of advertising insertion system 215, the validation server system 115 can signal the insertion system to modify its schedule to insert a different advertisement (e.g., another version of the advertisement) that contains the substitute EBIF application. Typically, the schedule is initially defined by the Ad Decision Service (ADS) 250.

According to particular embodiments, the validation services implemented by the validation server systems 110, 115 are preferably defined in the rules server system 120. The rules server system 120 enables a user to programmatically define (1) what elements of the EBIF application are to be validated, (2) how such elements of the EBIF application are to be validated and (3) what actions to take if the validation fails. These rules can be defined for applications on a global, class or individual basis. For example, different classes of applications can include applications defined using the standard EBIF format and applications defined using enhanced versions of the EBIF format that enable modification and substitution of alternative resources and/or applications. Individual applications can be identified by the video container file (e.g., MPEG file), application ID, MPEG table/PID signatures, and others). The rules server system 120 can be implemented as a separate server component coupled to the respective validation server system(s). Alternatively, the rules server system 120 can be integrated on the same server as the respective server system(s).

The validation system 1 can comprise event server system 130 that records events that occur in the other server system components of the validation system 1, such as validation failures and deletions, modifications or substitutions of an EBIF application, or specific resources thereof. Optionally, the event server system 130 can generate notifications when problems are found or actions are taken. Preferably, the recorded events can be utilized to provide comprehensive histories and analysis of EBIF modification activity for use by the operator and/or EBIF content providers, for example, to help them tune the provisioning/distribution of external resources meant to correlate with a given advertising campaign.

The validation system 1 can comprise a validation workstation 140 which provides a series of user interfaces through which a user can author EBIF applications enhanced with external resources using predefined templates. Such templates can include standard application tags, external resource reference tables and business rules to enable quick in-line application identification, referenced external resource extraction and appropriate modification.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device, for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network.

Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The terms “module” and “function,” as used herein, mean, but are not limited to, a software or hardware component which performs certain tasks. A module may advantageously be configured to reside on addressable storage medium and configured to execute on one or more processors. A module may be fully or partially implemented with a general purpose integrated circuit (IC), FPGA, or ASIC. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (PBX). In any of these cases, implementation may be achieved either by writing applications that are native to the chosen platform, or by interfacing the platform to one or more external application engines.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks. Communication networks can also all or a portion of the PSTN, for example, a portion owned by a specific carrier.

The computing system can include clients and servers. A client and server are generally remote from each other and typically interact through a communication network. The relationship of client and server arises by virtue of computer programs running on the respective computers and having a client-server relationship to each other.

While this invention has been particularly shown and described with references to preferred embodiments thereof, it will be understood by those skilled in the art that various changes in form and details may be made therein without departing from the scope of the invention encompassed by the appended claims.

What is claimed:

1. A computerized method of validating an application contained within a multimedia transport stream, comprising:
reading data from a multimedia transport stream by a computer, the data representing an application that presents viewable content when executed by a display device and comprises a reference to an identifier of an external resource utilized by the application during execution; and
prior to delivery of the multimedia transport stream to a display device, modifying the multimedia transport stream by the computer such that the external resource is not requested by the display device.

2. The computerized method of claim 1 further comprising:
determining by the computer whether the external resource is available; and
in response to the computer determining that the external resource is not available, modifying the multimedia transport stream by the computer such that the external resource is not requested by the display device.

3. The computerized method of claim 1 wherein modifying the multimedia transport stream comprises effectively deleting the application from the multimedia transport stream by removing a program element defining the packet identifier (PID) carrying the application from a Program Map Table present in the multimedia transport stream.

4. The computerized method of claim 1 wherein modifying the multimedia transport stream comprises effectively removing the external resource from the application by changing the reference from the identifier of the external resource to a null value.

5. The computerized method of claim 1 wherein modifying the multimedia transport stream comprises effectively removing the external resource from the application by changing the reference from the identifier of the external resource to an identifier of an alternative external resource.

6. The computerized method of claim 5 wherein effectively removing the external resource from the application further comprises obtaining the identifier of the alternative external resource from a data structure defined within the data representing the application, the data structure containing one or more identifiers associated with alternative external resources.

7. The computerized method of claim 5 wherein effectively removing the external resource from the application further comprises obtaining the identifier of the alternative external resource from a rules server.

8. The computerized method of claim 1 wherein the data representing the application further comprising data representing a primary content format and an alternative content format for presenting viewable content of the application, the data representing alternative content format lacking the reference to the external resource, and wherein modifying the multimedia transport stream comprises:
replacing the data representing the primary content format of the application with the data representing the alternative content format.

9. The computerized method of claim 1 wherein the multimedia transport stream further comprises data representing a primary application and an alternate application for presenting viewable content, the data representing the primary application and the alternate application each being associated with a different packet identifier (PID); and
wherein modifying the multimedia transport stream comprises effectively substituting the primary application with the alternate application in the multimedia transport stream by substituting the packet identifier of the primary application with the packet identifier of the alternate application in a Program Map Table present in the multimedia transport stream.

10. The computerized method of claim 1 wherein the multimedia transport stream is intercepted from a remote feed prior to delivery to the display device.

11. The computerized method of claim 1 wherein the multimedia transport stream is stored in a database in advance of delivery to the display device.

12. A computerized system for validating an application contained within a multimedia transport stream, comprising:
a validation server system connected to a computer network between a feed and a display device;
the validation server system intercepting a multimedia transport stream from the feed and reading data from the transport stream, the data representing an application that presents viewable content when executed by the display device and comprises a reference to an identifier of an external resource utilized by the application during execution;
prior to delivery of the multimedia transport stream to a display device, the validation server system modifying the multimedia transport stream such that the external resource is not requested by the display device.

13. A computerized system for validating an application contained within a multimedia transport stream, comprising:
a validation server system connected to a multimedia insertion server system that causes insertion of a stored multimedia transport stream into a scheduled timeslot of another multimedia transport stream being delivered to a display device;
the validation server system reading data from the stored multimedia transport stream, the data representing an application that presents viewable content when executed by the display device and comprises a reference to an identifier of an external resource utilized by the application during execution;
prior to insertion of the stored multimedia transport stream into the scheduled timeslot, the validation server system modifying the stored multimedia transport stream such that the external resource is not requested by the display device.

14. A computer program product, tangibly embodied in a computer readable medium, for validating an application contained within a multimedia transport stream, comprising instructions being executable to cause data processing apparatus to:
read data from a multimedia transport stream by a computer, the data representing an application that presents viewable content when executed by a display device and comprises a reference to an identifier of an external resource utilized by the application during execution; and
prior to delivery of the multimedia transport stream to a display device, modify the multimedia transport stream by the computer such that the external resource is not requested by the display device.
